(19) United States
(12) Patent Application Publication
(10) Pub. No.: US 2020/0232518 A1
(43) Pub. Date: Jul. 23, 2020

(54) CLUTCH DEVICE FOR A DRIVETRAIN OF A VEHICLE

(71) Applicant: Schaeffler Technologies AG & Co. KG, Herzogenaurach (DE)

(72) Inventors: Martin Chambrion, Erstein (FR); Clément Francois, Uhlwiller (FR)

(73) Assignee: Schaeffler Technologies AG & Co. KG, Herzogenaurach (DE)

(21) Appl. No.: 16/483,121

(22) PCT Filed: Mar. 8, 2018
(86) PCT No.: PCT/DE2018/100207

§ 371 Date: Aug. 2, 2019

(30) Foreign Application Priority Data
Mar. 31, 2017 (DE) 10 2017 106 951.8

(51) Int. Cl. F16D 13/68; F16D 13/71; F16D 13/56; F16D 13/64

(52) U.S. Cl. CPC F16D 13/68; F16D 13/71; F16D 2013/706; F16D 13/646; F16D 13/56

(57) ABSTRACT

A clutch device includes first frictional elements and second frictional elements connectable to the first frictional elements. The clutch device has a hub connected to a first part of the second frictional elements, a movable contact plate connected to a second part of the second frictional elements, a disengaging plate for actuating the contact plate, and a pressure disk. A first bolt extends through the pressure disk and includes a first end attached to the disengaging plate, and a second end attached to the contact plate. A compression spring is positioned between the first end and the pressure disk. A leaf spring is joined to the contact plate and to the hub. A first centrifugal unit is arranged to move the pressure disk in the axial direction against the compression spring to clamp the first and second frictional elements when a first speed of rotation is reached.

### CROSS-REFERENCE TO RELATED APPLICATIONS

This application is the United States National Phase of PCT Appln. No. PCT/DE2018/100207 filed Mar. 8, 2018, which claims priority to German Application No. DE102017106951.8 filed Mar. 31, 2017, the entire disclosures of which are incorporated by reference herein.

### TECHNICAL FIELD

The disclosure relates to a clutch device for a drivetrain of a vehicle, having a first clutch component for introducing torque and a second clutch component for transmission of torque, the second clutch component being rotationally uncouplable from the first clutch component. First frictional elements of the first clutch component and second frictional elements of the second clutch component may be connectible so that they transmit torque.

### BACKGROUND

A clutch device of this species is known from WO 2014/139526 A1. The latter discloses a clutch device comprising an input side and an output side, which are arranged rotatably around an axis and have at least one first frictional partner and at least one second frictional partner. The first frictional partner is connected torsionally to the input side, the second frictional partner is connected torsionally to the output side, and the first and second frictional partners may be brought into frictional engagement by a clamping force in order to transmit torque between the input side and the output side. At least one spring means is provided which amplifies the clamping force of the clutch device.

Such spring means are designed in general as leaf springs, which are able to produce an amplification of the clamping force due to their installation angle. In this case, the load on the leaf springs depends on the number of frictional elements which transmit their torque through the leaf springs to a hub.

It is proposed in DE 10 2016 207 116.5 that the number of friction surfaces which provide self-amplification of the clamping force be reduced.

From WO 2015/135540 A1, a centrifugal clutch is known which, on the one hand, has a centrifugally engaging and disengaging switching apparatus in the centrifugal clutch that serves as a starting element, and, on the other hand, has a disengaging apparatus operable by the driver as an engaging and disengaging clutch, which opens and closes the engaged centrifugal clutch against the centrifugal force.

Also known are centrifugal clutches whose second clutch component has an additional centrifugally engaging and disengaging switching apparatus. This makes it possible both to start to drive the motor vehicle with the drive unit rotating at a high speed, as well as to drive at low rotational speeds, for example under partial load, under which disengagement of the centrifugal clutch due to centrifugal force does not occur until lower rotational speeds are reached.

### SUMMARY

A clutch device for a drivetrain of a vehicle is proposed, having an axis of rotation, a first clutch component for introducing torque and a second clutch component for transmission of torque. The second clutch component is rotationally uncouplable from the first clutch component, the first clutch component having first frictional elements and the second clutch component having second frictional elements which are connectible so that they transmit torque, while a partial self-amplification of the clutch device is executable by means of a leaf spring unit. The second clutch component includes at least the following components:
a hub, which is connectible to a drive shaft, the hub being connected non-rotatingly to a first part of the second frictional elements (in the circumferential direction);
a contact plate, which is movable along the axis of rotation in an axial direction relative to the hub, the contact plate being connected non-rotatingly to a second part of the second frictional elements (in the circumferential direction).
a disengaging plate for actuating the contact plate (to activatably disengage the clutch device and decouple the second clutch component from the first clutch component, also against a centrifugal force);
a pressure disk;
a plurality of first bolts, each extending in the axial direction, the disengaging plate being attached to a first end of the first bolt and the contact plate being attached to a second end; the first bolts extend through the pressure disk and the pressure disk is positioned movably in the axial direction relative to the first bolt; a compression spring is positioned between the first end and the pressure disk;
a plurality of leaf springs (or leaf spring assemblies), which extend in the circumferential direction and are joined by a first leaf spring end to the contact plate (for example by means of the second end of the first bolt) and by a second leaf spring end to the hub (for example by means of a fourth bolt);
a first centrifugal unit, by means of which the first and second frictional elements are clampable to one another in the axial direction; when a first speed of rotation is reached, the first centrifugal unit acts on the pressure disk and moves it in the axial direction against the compression springs (and thereby clamps the frictional elements together).

In an example embodiment, the installation angle of the leaf springs of the leaf spring unit is between 40° and 55°. This relatively large installation angle of the leaf springs reduces the variation of the self-amplification, which prolongs the life of the leaf springs. In an example embodiment, the leaf spring unit is joined, on the one hand, to the hub and, on the other hand, to the contact plate, and a specified second part of the second frictional element of the second clutch component is connected rotationally to the contact plate through the leaf spring unit. A specified first part of the second frictional element of the second clutch component is joined directly to the hub. The contact plate and the hub are coupled rotationally with each other by means of the leaf springs and uncoupled from each other relative to an axial direction. That is, the contact plate is movable relative to the hub in the axial direction against the force of the leaf spring unit.

The first centrifugal unit may be connected non-rotatingly to the first clutch component or to the second clutch component. In an example embodiment, a second centrifugal unit is provided, which acts on the pressure disk when a second speed of rotation is reached and moves it in the axial direction against the compression springs. The first centrifugal unit is (then) connected non-rotatingly to the second clutch component and the second centrifugal unit to the first clutch component. The first centrifugal unit ensures, for example, that clamping of the frictional elements is maintained down to a low first speed of rotation when a vehicle is moving. The second centrifugal unit ensures, for example, that clamping of the frictional elements begins when a second speed of rotation is reached, even when a vehicle is stationary (starting clutch). The first centrifugal unit may have a first plate which is movable in the axial direction as the centrifugal force changes, which actuates the pressure disk by means of at least one second bolt.

In an example embodiment, the at least one second bolt is attached only to the pressure disk. The second bolt may be connected to the pressure disk by means of a riveted connection. In an example embodiment, the second bolt extends in the axial direction, starting from the pressure disk, through the contact plate to the first plate.

Movement of the first plate as a result of a centrifugal force actuates the second bolt, so that the pressure disk is moved by the second bolt against the spring force of the compression spring. The compression springs are each attached to the first end of the first bolts, and are clamped between the first end of the first bolt and the pressure disk. Movement of the pressure disk against the spring force of the compression springs acts on the first end of the first bolts, so that all of the first bolts are moved in the axial direction by the compression springs. Shifting the first bolts also causes the contact plate to move, so that the frictional elements are clamped together.

In an example embodiment, the pressure disks may only be shifted for a predetermined distance in the axial direction. In an example embodiment, this distance is limited by a stop, which is formed with the hub. In this way, the spring force acting on the frictional elements can be limited (on the one hand by the stop and, on the other hand, by the spring force of the compression springs). In an example embodiment, the second centrifugal unit has a second plate which is movable in the axial direction as the centrifugal force changes, which actuates the first plate by means of at least one third bolt, thus actuating the pressure disk by means of the at least one second bolt.

In an example embodiment, the at least one third bolt is attached only to the first plate. The at least one third bolt may be rotationally uncoupled relative to the second centrifugal unit, so that a rotary movement of the second centrifugal unit transmits no appreciable force to the at least one third bolt in the circumferential direction. In an example embodiment, of the first, second, third and/or fourth bolts, at least two, e.g., three or even more than three bolts are provided.

In an example embodiment, the clutch device comprises a plurality of sub-assemblies which are producible independently of each other. A first sub-assembly includes the hub, the contact plate, the pressure disk, the plurality of first bolts with the compression springs, and the leaf springs. In an example embodiment, the first sub-assembly includes in addition the fourth bolts, by means of which the leaf springs are joined to the hub. The first sub-assembly may include the second bolts, which are attached in particular to the pressure disk. In an example embodiment, the second sub-assembly includes the first sub-assembly and the first centrifugal unit, the first centrifugal unit being connected non-rotatingly to the hub and being positionable on the hub by means of a locking ring.

In an example embodiment, the first centrifugal unit has a base plate, which has on an inner circumferential surface tongues which mesh with grooves in the hub, thus guaranteeing a non-rotating arrangement of the first centrifugal unit on the hub. In an example embodiment, the second sub-assembly includes in addition the third bolts, which are attached to the second plate. In an example embodiment, a third sub-assembly includes the first clutch component and a second centrifugal unit, which is connected non-rotatingly to the first clutch component. A fourth sub-assembly may include the first frictional elements and the second frictional elements.

The disclosure also provides a method for producing the clutch device including at least the following steps—independent of each other:

a) assembling the first sub-assembly (possibly including the first centrifugal unit);

b) assembling the third sub-assembly; and then:

c) providing the fourth sub-assembly;

d) assembling the first (or second) sub-assembly with the third sub-assembly and the fourth sub-assembly.

The comments on the clutch device apply equally to the method, and vice versa. The disengaging plate may be pulled or pushed by a clutch release bearing.

Let it be noted, as a precaution, that the ordinal numbers (“first,” “second,” . . . ) used here serve primarily (only) to differentiate among a plurality of similar objects, values or processes, so that, for example, they do not necessarily indicate any dependence and/or sequential order of these objects, values or processes relative to each other. If a dependence and/or sequential order should be necessary, that must be stated here specifically or must be obvious to a person skilled in the art when studying the concretely described design.

### BRIEF DESCRIPTION OF THE DRAWINGS

The disclosure will be explained in greater detail below on the basis of the figures. It should be pointed out that the disclosure is not to be limited by the exemplary embodiments shown. For example, it is also possible, unless explicitly shown otherwise, to extract partial aspects of the circumstances explained in the figures and to combine them with other components and insights from the present description and/or figures. The figures, and especially the depicted size proportions, are only schematic. Like reference labels designate like objects, so that explanations from other figures may be cited in addition, as appropriate. The figures show the following:

FIG. 1 is a known clutch device in perspective cross section;

FIG. 2 is a clutch device with a counter plate and an output shaft in perspective cross section;

FIG. 3 is a first sub-assembly of the clutch device according to FIG. 2 in perspective view;

FIG. 4 is a second sub-assembly of the clutch device according to FIG. 2 in perspective view;

FIG. 5 is a view of the second sub-assembly according to FIG. 4 from below along the axis of rotation;

FIG. 6 is a third sub-assembly of the clutch device according to FIG. 2 in perspective view;

FIG. 7 is a clutch device according to FIG. 2 with the first, second, third and fourth sub-assemblies and the output shaft, in perspective view;

FIG. 8 is a hub of the clutch device according to FIG. 2 in perspective view; and

FIG. 9 is a contact plate of the clutch device according to FIG. 2 in perspective view.

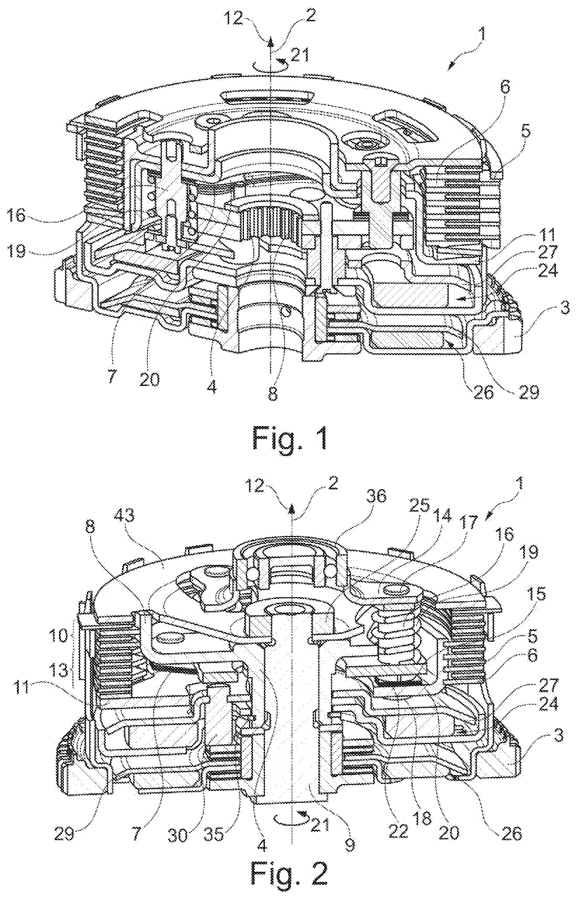

FIG. 1 shows a known clutch device 1 in perspective cross section. The clutch device 1 with an axis of rotation 2 has a first clutch component 3, which is connectible to a crankshaft of a combustion engine to provide an indirect or direct rotary connection. The first clutch component 3 has a sleeve-shaped outer plate carrier, which is coupled rotationally by means of its radial inner surface to a plurality of first frictional elements 5 in the form of first friction plates (so that it forms a positive lock).

Along with the first clutch component 3, the clutch device 1 includes a second clutch component 4, which is coupled rotationally with second frictional elements 6 in the form of the second friction plates (so that it forms a positive lock in the circumferential direction 21). The first clutch component 3 is rotationally uncoupled from the second clutch component 4, or connected to the latter non-rotatingly by means of the frictional elements 5, 6, depending on the position of the clutch device 1.

The first frictional elements 5 of the first clutch component 3 and the second frictional elements 6 of the second clutch component 4 are arranged in the axial direction 12 so that between each two adjacent first frictional elements 5 in principle a second frictional element 6 of the second clutch component 4 is always positioned. The frictional elements 5, 6 are all movable in the axial direction 12 relative to each other. When the clutch device 1 is in the engaged position, the first and second frictional elements 5, 6 are connected non-rotatingly with one another and frictionally locked by means of an applied connecting force in the form of the axial contact force which is produced by the centrifugal units 24, 26. When the clutch device 1 is in the disengaged position, the first and second frictional elements 5, 6 are again positioned without force relative to one another, and thus are rotatable relative to one another.

Here, the first centrifugal unit 24 is connected with the hub 8 by means of a screwed connection. A leaf spring unit 7 connects the contact plate 11 to the hub 8. A first plate 27 of the first centrifugal unit 24 acts on a compression spring 19, and on the contact plate 11 through the compression spring 19.

FIG. 2 shows a clutch device 1 with counter plate 43 and output shaft 9 in perspective cross section. The clutch device 1 includes an axis of rotation 2, a first clutch component 3 to introduce torque and a second clutch component 4 to transmit torque. The second clutch component 4 is rotationally uncouplable from the first clutch component 3, the first clutch component 3 having first frictional elements 5 and the second clutch component 4 having second frictional elements 6, which are connectible so that they transmit torque, while a partial self-amplification of the clutch device 1 is executable by means of a leaf spring unit 7. The second clutch component 4 includes a hub 8, which is connected non-rotatingly to a drive shaft 9, the hub 8 being connected non-rotatingly to a first part 10 of the second frictional elements 6 (in the circumferential direction 21).

In addition, a contact plate 11, which is movable along the axis of rotation 2 in an axial direction 12 relative to the hub 8, is connected non-rotatingly to a second part 13 of the second frictional elements 6 (in the circumferential direction 21). Furthermore, the second clutch component 4 includes a disengaging plate 14 for actuating the contact plate 11 (to activatably disengage the clutch device 1 and decouple the second clutch component 4 from the first clutch component 3, also against a centrifugal force), as well as a contact plate 15. In addition, the second clutch component 4 includes a plurality of first bolts 16, each extending in the axial direction 12, the disengaging plate 14 being attached to a first end 17 of the first bolt 16 and the contact plate 11 being attached to a second end 18. The first bolts 16 extend through the pressure disk 15 and the pressure disk 15 is positioned movably in the axial direction 12 relative to the first bolt 16.

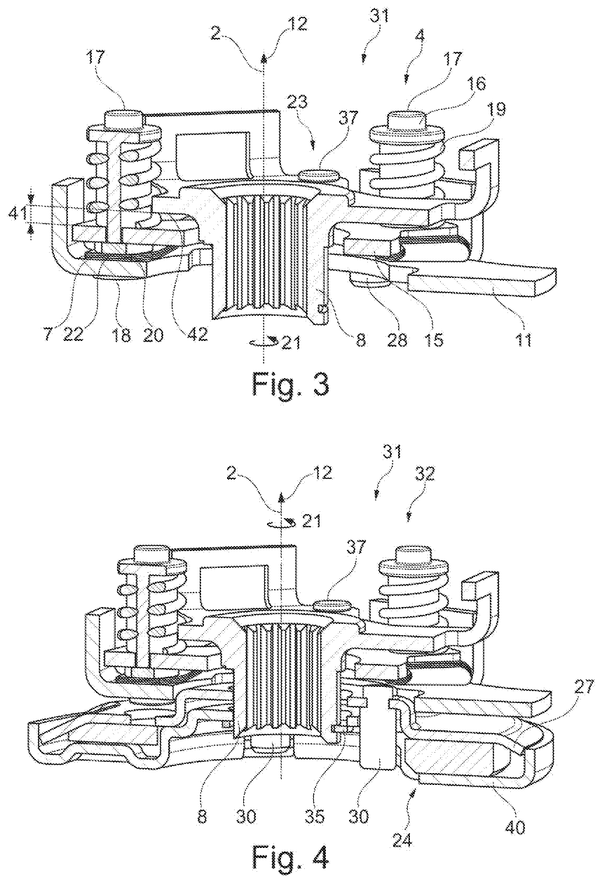

Positioned between the first end 17 and the pressure disk 15 is a compression spring 19. In addition, the second clutch component 4 includes a plurality of leaf springs 20 (or leaf spring assemblies), which extend in the circumferential direction 21 and are joined by a first leaf spring end 22 to the contact plate 11 (for example, by means of the second end 18 of the first bolt 16) and by a second leaf spring end 23 (ref. FIG. 3) to the hub 8 (for example by means of a fourth bolt 37). In addition, the second clutch component 4 includes a first centrifugal unit 24, by means of which the first and second frictional elements 5, 6 are clampable to one another in the axial direction 12; when a first speed of rotation is reached, the first centrifugal unit 24 acts on the pressure disk 15 and moves it in the axial direction 12 against the compression springs 19 (and thereby clamps the frictional elements 5, 6 together).

The leaf spring unit 7 is joined, on the one hand, to the hub 8 and, on the other hand, to the contact plate 11, and a specified second part 13 of the second frictional element 6 of the second clutch component 4 is connected rotationally to the contact plate 11 through the leaf spring unit 7. A specified first part 10 of the second frictional element 6 of the second clutch component 4 is joined directly to the hub 8. The contact plate 11 and the hub 8 are coupled rotationally with each other by means of the leaf springs 20 and uncoupled from each other relative to an axial direction 12; that is, the contact plate 11 is movable relative to the hub 8 in the axial direction 12 against the force of the leaf spring unit 7.

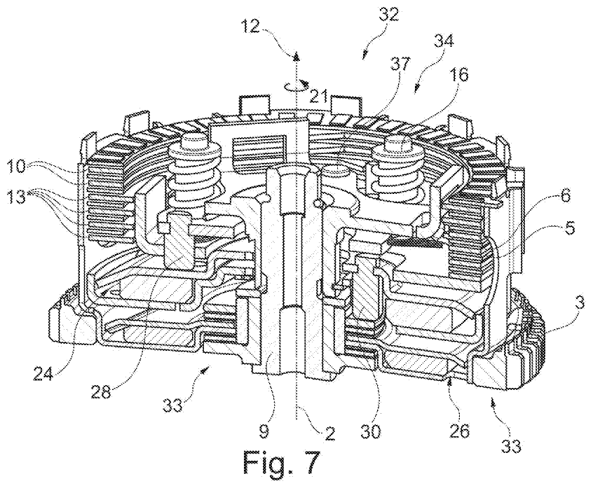

Here, a second centrifugal unit 26 is provided, which acts on the pressure disk 15 when a second speed of rotation is reached and moves it in the axial direction 12 against the compression springs 19; the first centrifugal unit 24 is connected non-rotatingly to the second clutch component 4 and the second centrifugal unit 26 to the first clutch component 3. The first centrifugal unit 24 ensures that clamping of the frictional elements 5, 6 is maintained down to a low first speed of rotation when a vehicle is moving. The second centrifugal unit 26 ensures in particular that clamping of the frictional elements 5, 6 begins when a second speed of rotation is reached, even when a vehicle is stationary (starting clutch). The first centrifugal unit 24 has a first plate 27 which is movable in the axial direction 12 as the centrifugal force changes, which actuates the pressure disk 15 by means of at least one second bolt 28 (see FIG. 7).

The at least one second bolt 28 is attached only to the pressure disk. The second bolt 28 is connected to the pressure disk 15 by means of a riveted connection. The second bolt 28 extends in the axial direction 12, starting from the pressure disk 15, through the contact plate 11 to the first plate 27. Movement of the first plate 27 as a result of a centrifugal force actuates the second bolt 28, so that the pressure disk 15 is moved by the second bolt 28 against the spring force of the compression spring 19. The compression springs 19 are each attached to a first end 17 of the first bolts 16, and are clamped between the first end 17 of the first bolt 16 and the pressure disk 15.

Movement of the pressure disk 15 against the spring force of the compression springs 19 acts on the first end 17 of the first bolts 16, so that all of the first bolts 16 are moved in the axial direction 12 by the compression springs 19. Shifting the first bolts 16 also causes the contact plate 11 to move relative to the counter plate 43, which is fixed on the output shaft 9 by means of a nut 25, so that the frictional elements 5, 6 are clamped together.

The second centrifugal unit 26 has a second plate 29 which is movable in the axial direction 12 as the centrifugal force changes, which actuates the first plate 27 by means of at least one third bolt 30 and thus actuates the pressure disk 15 by means of the at least one second bolt 28. The at least one third bolt 30 is attached only to the first plate 27, by means of a riveted connection. The at least one third bolt 30 is rotationally uncoupled relative to the second centrifugal unit 26, so that a rotary movement of the second centrifugal unit 26 transmits no appreciable force to the at least one third bolt 30 in the circumferential direction 21. Three bolts each of the first, second, third and fourth bolts 16, 28, 30, 37 are provided here.

FIG. 3 shows a first sub-assembly 31 of the clutch device 1 according to FIG. 2 in perspective view. The first sub-assembly 31 includes the hub 8, the contact plate 11, the pressure disk 15, the plurality of first bolts 16 with the compression springs 19, and the leaf springs 20. Also provided here are the fourth bolts 37, by means of which the second leaf spring ends 23 are attached to the hub 8. The pressure disks 15 may only be shifted for a predetermined distance 41 in the axial direction 12. This distance 41 is limited by a stop 42, which is formed with the hub 8. In this way, the spring force acting on the frictional elements 5, 6 can be limited (on the one hand by the stop 42 and on the other hand by the spring force of the compression springs 19). Here, the first sub-assembly 31 also includes the third bolts 28, which are attached to the pressure disk 15.

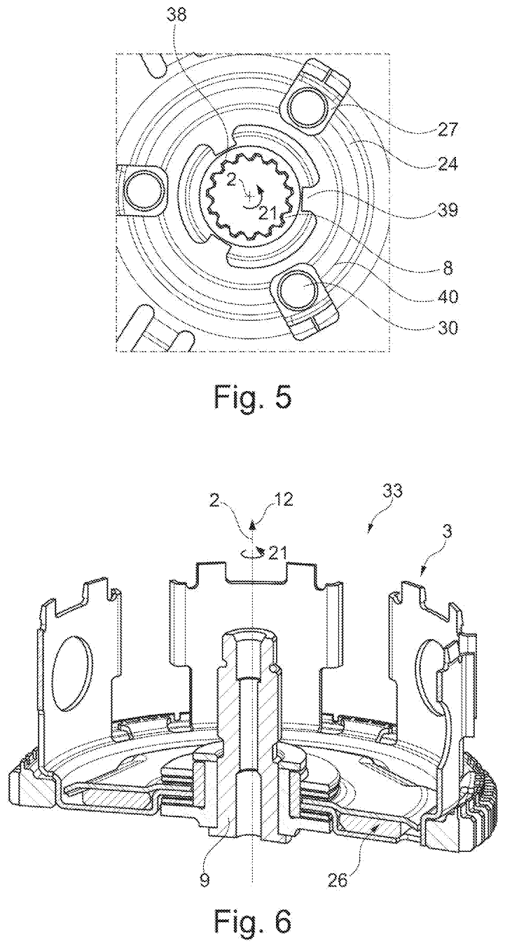

FIG. 4 shows a second sub-assembly 32 of the clutch device 1 according to FIG. 2 in perspective view. FIG. 5 shows a view of the second sub-assembly 32 according to FIG. 4 from below along the axis of rotation 2. FIGS. 4 and 5 will be described together below. The second sub-assembly 32 includes the first sub-assembly 31 and the first centrifugal unit 24, the first centrifugal unit 24 being connected non-rotatingly to the hub 8 and being positioned on the hub by means of a locking ring 35.

The first centrifugal unit 24 has a base plate 40, which has on an inner circumferential surface tongues 39 which mesh with grooves 38 in the hub 8, and thus guarantee a non-rotating arrangement of the first centrifugal unit 24 on the hub 8. Here, the second sub-assembly 32 includes in addition the third bolts 30, which are attached to the second plate 27.

FIG. 6 shows a third sub-assembly 33 of the clutch device 1 according to FIG. 2 in perspective view, and in addition the output shaft 9. The third sub-assembly 33 includes the first clutch component 3 and a second centrifugal unit 26, which is connected non-rotatingly to the first clutch component 3. The third sub-assembly 33 is positioned rotatably relative to the output shaft 9.

FIG. 7 shows a clutch device 1 according to FIG. 2 with the first, second, third and fourth sub-assemblies 31, 32, 33, 34 and the output shaft 9, in perspective view. The fourth sub-assembly 34 includes the first frictional elements 5 and the second frictional elements 6. Also shown here is the output shaft 9. See the comments on FIG. 2.

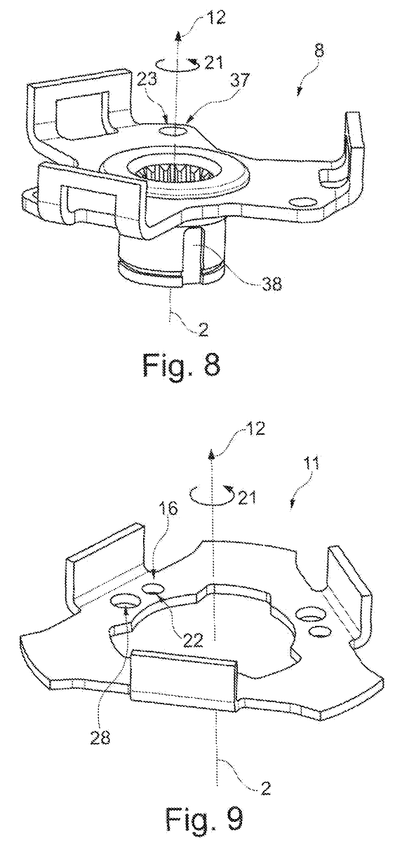

FIG. 8 shows a hub 8 of the clutch device 1 according to FIG. 2 in perspective view. See the previous comments, in particular on FIG. 2. The hub 8 has drilled holes to receive the fourth bolts 37 to attach the second leaf spring ends 23.

FIG. 9 shows a contact plate 11 of the clutch device 1 according to FIG. 2 in perspective view. See the previous comments, in particular on FIG. 2. The contact plate 11 has drilled holes, on the one hand to receive the second ends 17 of the first bolts 16 and the first leaf spring ends 22, and on the other hand for the second bolts 28.

### REFERENCE NUMERALS

1 clutch device

2 axis of rotation

3 first clutch component

4 second clutch component

5 first frictional element

6 second frictional element

7 leaf spring unit

8 hub

9 output shaft

10 first part

11 contact plate

12 axial direction

13 second part

14 disengaging plate

15 pressure disk

16 first bolt

17 first end

18 second end

19 compression spring

20 leaf spring

21 circumferential direction

22 first leaf spring end

23 second leaf spring end

24 first centrifugal unit

25 nut

26 second centrifugal unit

27 first plate

28 second bolt

29 second plate

30 third bolt

31 first sub-assembly

32 second sub-assembly

33 third sub-assembly

34 fourth sub-assembly

35 locking ring

36 release bearing

37 fourth bolt

38 groove

39 tongue

40 first base plate

41 distance

42 stop

43 counter plate

1.-10. (canceled)

11. A clutch device for a drivetrain of a vehicle comprising:
an axis of rotation defining an axial direction;
a first clutch component for introducing a torque, the first clutch component comprising first frictional elements;
a second clutch component for transmitting the torque, the second clutch component being rotationally uncouplable from the first clutch component and comprising:
second frictional elements connectable to the first frictional elements to transmit the torque, the second frictional elements comprising a first part and a second part;
a hub connected non-rotatingly to the first part of the second frictional elements and connectible to a drive shaft;
a contact plate:
movable relative to the hub in the axial direction; and
connected non-rotatingly to the second part of the second frictional elements;
a disengaging plate for actuating the contact plate;
a pressure disk;
a first bolt extending through the pressure disk in the axial direction such that the pressure disk is movable in the axial direction relative to the first bolts, the first bolt comprising:
a first end attached to the disengaging plate;
a second end attached to the contact plate;
a compression spring positioned between the first end and the pressure disk;
a leaf spring extending in a circumferential direction for partial self-amplification of the clutch device, comprising:
a first leaf spring end joined to the contact plate; and,
a second leaf spring end joined to the hub; and
a first centrifugal unit arranged to move the pressure disk in the axial direction against the compression spring to clamp the first frictional elements to the second frictional elements when a first speed of rotation is reached.

12. The clutch device of claim 11, further comprising a second centrifugal unit that moves the pressure disk in the axial direction against the compression spring when a second speed of rotation is reached, wherein:
the first centrifugal unit is connected non-rotatingly to the second clutch component; and
the second centrifugal unit is connected non-rotatingly to the first clutch component.

13. The clutch device of claim 12, wherein:
the first centrifugal unit comprises a first plate and a second bolt; and
the first plate is movable in the axial direction to move the pressure disk with the second bolt.

14. The clutch device of claim 13, wherein the second bolt is only attached to the pressure disk.

15. The clutch device of claim 13, wherein:
the second centrifugal unit comprises a second plate and a third bolt; and
the second plate is movable in the axial direction to move the first plate with the third bolt.

16. The clutch device of claim 15, wherein the third bolt is only attached to the first plate.

17. The clutch device of claim 11, further comprising:
a first sub-assembly comprising the hub, the contact plate, the pressure disk, the first bolt, the compression spring, and the leaf spring; and
another sub-assembly producible independent of the first sub-assembly.

18. The clutch device of claim 17, further comprising:
a second sub-assembly comprising:
the first sub-assembly;
a locking ring; and
the first centrifugal unit connected non-rotatingly to the hub and positioned on the hub by the locking ring.

19. The clutch device of claim 17, further comprising a third sub-assembly comprising:
the first clutch component; and
a second centrifugal unit connected non-rotatingly to the first clutch component.

20. The clutch device of claim 17 further comprising a fourth sub-assembly comprising:
the first frictional elements; and
the second frictional elements.
